(19) United States
(12) Patent Application Publication
(10) Pub. No.: US 2017/0289550 A1
(43) Pub. Date: Oct. 5, 2017

(54) METHOD AND APPARATUS ADJUSTING A BITRATE IN REAL TIME, AND SERVER DEVICE

(71) Applicants: Le Holdings (Beijing) Co., Ltd., Beijing (CN); Le Cloud Computing Co., Ltd, Beijing (CN)

(72) Inventors: Maosheng Bai, Beijing (CN); Chao Lv, Beijing (CN); Wei Wei, Beijing (CN)

(73) Assignees: Le Holdings (Beijing) Co., Ltd., Beijing (CN); Le Cloud Computing Co., Ltd., Beijing (CN)

(21) Appl. No.: 15/246,294

(22) Filed: Aug. 24, 2016

Related U.S. Application Data
(63) Continuation of application No. PCT/CN2016/088948, filed on Jul. 6, 2016.

(30) Foreign Application Priority Data
Mar. 30, 2016 (CN) 201610195615.3

(51) Int. Cl. H04N 19/146; H04N 19/172; H04N 19/42

(52) U.S. Cl. CPC H04N 19/146; H04N 19/42; H04N 19/172

(57) ABSTRACT

Embodiments of the disclosure disclose a method and apparatus for adjusting a bitrate in real time, and a server device, the method including: synchronizing frames across multiple threads in response to a bitrate adjusting instruction; obtaining parameters in a bitrate control logic to determine the bitrate, after the frames are synchronized; calculating the value of each parameter at the current bitrate as a current value; calculating a target value of each parameter at a target bitrate according to a proportional relationship between the current bitrate and the target bitrate corresponding to the bitrate adjusting instruction, and the current value of the corresponding parameter; modifying the value of each parameter to the target value corresponding thereto; and performing subsequent encoding to synchronization of the frames, using the value of each parameter modified.

### CROSS REFERENCE TO RELATED APPLICATIONS

This application is a continuation of International Application No. PCT/CN2016/088948, filed on Jul. 6, 2016, which is based upon and claims priority to Chinese Patent Application No. 201610195615.3, filed on Mar. 30, 2016, the entire contents of which are incorporated herein by reference

### TECHNICAL FIELD

The present disclosure relates to the field of audio and video encoding, and particularly to a method for adjusting a bitrate in real time, an apparatus for adjusting a bitrate in real time capable of performing the method for adjusting a bitrate in real time, and a server device capable of performing the method for adjusting a bitrate in real time.

### BACKGROUND

A code rate or a bitrate, refers to the number of bits transmitted per second of encoded (compressed) audio and video data, i.e., the amount of data compressed image displayed per second, typically in kbps or mpbs.

There are two existing encoding schemes including Constant Bitrate (CBR) and Variable Bitrate (VBR), where information traffic transmitted per second is substantially invariable given a preset bitrate in the former encoding scheme; and information traffic transmitted per second is variable so that a particular bitrate for encoding can be determined by the system as a function of the amount of image data to thereby make full use of a space in the latter encoding scheme.

However the inventors of the disclosure have identified that in either the CBR encoding scheme or the VBR encoding scheme, the bitrate is adjusted in response to a received bitrate adjusting instruction typically by stopping encoding, setting a new bitrate, and encoding again at the new bitrate, so that rendering of a video may be interrupted, thus making it impossible to transition smoothly.

### SUMMARY

An object of embodiments of the disclosure is to provide an innovative technical solution to adjusting a bitrate so as to transition smoothly between different bitrates.

In a first aspect of the embodiments of the disclosure, there is provided a method for adjusting a bitrate in real time, the method including:
synchronizing frames across multiple threads in response to a bitrate adjusting instruction;
obtaining parameters in a bitrate control logic to determine the bitrate, after the frames are synchronized;
calculating the value of each parameter at the current bitrate as a current value;
calculating a target value of each parameter at a target bitrate according to a proportional relationship between the current bitrate and the target bitrate corresponding to the bitrate adjusting instruction, and the current value of the corresponding parameter;
modifying the value of each parameter to the target value corresponding thereto; and
performing subsequent encoding to synchronization of the frames, using the value of each parameter modified.

In a second aspect of the embodiments of the disclosure, there is provided an apparatus for adjusting a bitrate in real time, the apparatus including:
at least one processor; and
a memory communicably connected with the at least one processor for storing instructions executable by the at least one processor, wherein execution of the instructions by the at least one processor causes the at least one processor to:
synchronize frames across multiple threads in response to a bitrate adjusting instruction;
obtain parameters in a bitrate control logic to determine the bitrate after the frames are synchronized, and calculate the value of each parameter at the current bitrate as a current value;
calculate a target value of each parameter at a target bitrate according to a proportional relationship between the current bitrate and the target bitrate corresponding to the bitrate adjusting instruction and the current value of the corresponding parameter;
modify the value of each parameter to the target value corresponding thereto; and
perform subsequent encoding to synchronization of the frames, using the value of each parameter modified.

In a third aspect of the embodiments of the disclosure, there is provided A non-transitory computer-readable storage medium storing executable instructions that, when executed by an apparatus for adjusting a bitrate in real time, cause the apparatus to:
synchronize frames across multiple threads in response to a bitrate adjusting instruction;
obtain parameters in a bitrate control logic to determine the bitrate after the frames are synchronized, and calculate the value of each parameter at the current bitrate as a current value;
calculate a target value of each parameter at a target bitrate according to a proportional relationship between the current bitrate and the target bitrate corresponding to the bitrate adjusting instruction and the current value of the corresponding parameter;
modify the value of each parameter to the target value corresponding thereto; and perform subsequent encoding to synchronization of the frames, using the value of each parameter modified.

In the embodiments of the disclosure, the bitrate can be adjusted in real time response to the bitrate adjusting instruction while encoding to thereby transition smoothly while the bitrate is being adjusted.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed:

FIG. 1 illustrates a flow chart of an implementation of a method for adjusting a bitrate in real time in accordance with some embodiments;

FIG. 2 illustrates a principle structural block diagram of an implementation of an apparatus for adjusting a bitrate in real time in accordance with some embodiments;

FIG. 3 illustrates a principle structural block diagram of an implementation of a server device in accordance with some embodiments; and

FIG. 4 is a schematic structural diagram of apparatus for adjusting a bitrate in accordance with some embodiments.

### DETAILED DESCRIPTION

Various exemplary embodiments of the disclosure will be described below in details with reference to the drawings. It shall be noted that unless stated otherwise, relative arrangements of components and operations, numeral expressions, and values, which are set forth in these embodiments will not limit the scope of the disclosure.

The following description of at least one exemplary embodiment is merely illustrative indeed, but not intended to limit the disclosure and its applications or uses in any way.

Techniques, methods, and devices known to those skilled in the art may not be discussed in details, but shall be construed as a part of the specification if appropriate.

Any particular values throughout the examples illustrated and discussed here shall be constructed as merely illustrative, but not intended to be limiting. Accordingly there may be different values in other examples of the exemplary embodiments.

It shall be noted that like reference numerals and symbols will refer to like elements throughout the drawings, so if some element is defined in one of the drawings, then it will not be further discussed in subsequent drawings.

In view of the problem of an interruption in the existing method for adjusting a bitrate in real time, the embodiments of the disclosure provide an innovative technical solution to adjusting a bitrate so as to transition smoothly while the bitrate is being adjusted.

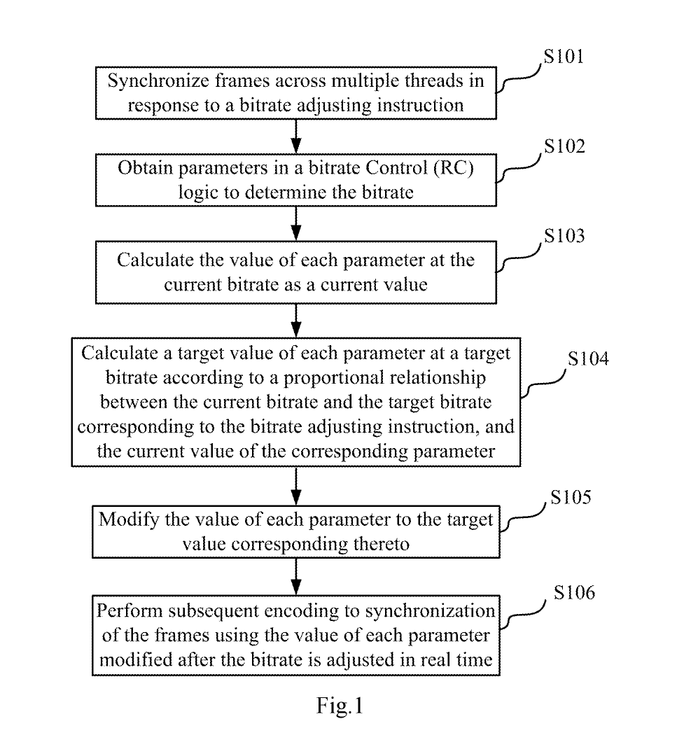

FIG. 1 illustrates a flow chart of an implementation of a method for adjusting a bitrate in real time according to an embodiment of the disclosure.

As illustrated in FIG. 1, the method for adjusting a bitrate in real time according to the embodiment of the disclosure can include the following operations:

The operation S101 is to synchronize frames across multiple threads in response to a bitrate adjusting instruction.

The bitrate adjusting instruction can be triggered by a video source provider or a video platform provider to match the bitrate with a channel capacity to thereby render a video smoothly.

Since encoding operations are generally based upon in multiple threads, that is, the encoding operations are typically performed as concurrent logic operations in a number frames, for example, the first thread is occupied for pre-processing in the first frame, the second thread is occupied for making a decision in the second frame, the third thread is occupied for compression in the third frame, etc., so the frames need to be synchronized across the threads upon reception of the bitrate adjusting instruction to thereby ensure the bitrate to be adjusted synchronously in the respective frames.

The frames can be synchronized across the threads by controlling the respective threads to finish the same logic operation in the current frames for processing, that is, to finish compression in the respective first frame, second frame, and third frame in the example above.

The frames can be synchronized across the threads preferably by controlling the respective threads to finish the current logic operations in the current frames for processing, that is, the first thread to finish pre-processing in the first frame, the second thread to finish making of a decision in the second frame, the third thread to finish compression in the third frame, etc., in the example above, so that subsequent encoding in the respective frames can be performed synchronously after the bitrate is adjusted. This frame synchronization scheme can facilitate improve real-time adjusting of the bitrate.

After the frames are synchronized, the bitrate can be adjusted as follows, and the following operations S102 to S105 can be performed:

The operation S102 is to obtain parameters in a bitrate Control (RC) logic to determine the bitrate.

There may be different parameters to determine the bitrate in a different bitrate control logic, particularly one or more key parameters with high weights to determine the bitrate. For the majority of bitrate control logics, the bitrate is substantially determined by two parameters including the average of complexities of contents in a period of time of interest, and the number of bits processed in the period of time of interest, both of which are the key parameters particularly for an H.264 based bitrate control logic. Thus in a particular embodiment of the disclosure, the bitrate is adjusted using the H.264 based bitrate control logic, and the average of complexities of contents in a period of time of interest, and the number of bits processed in the period of time of interest are preset as the parameters to determine the bitrate.

The period of time of interest is determined by the bitrate control logic in use, and particularly preset by the bitrate control logic to thereby control the current bitrate taking into account encoding information in the preset period of time prior to the current point of time. For example, if the period of time of interest is preset globally, then the period of time of interest will be a global period of time from the beginning of encoding till the beginning of adjusting the bitrate; and if the period of time of interest is preset to one second, then the period of time of interest will be a period of time one second before the bitrate is adjusted.

The operation S103 is to calculate the value of each parameter at the current bitrate as a current value.

The operation S104 is to calculate a target value of each parameter at a target bitrate according to a proportional relationship between the current bitrate and the target bitrate corresponding to the bitrate adjusting instruction, and the current value of the corresponding parameter.

In this operation, the target value of each parameter is predicated as a function of a difference between previous encoding at the target bitrate, and previous encoding at the current bitrate, where this operation can further include the following sub-operations:

The first sub-operation S1041 is to map the ratio of the current bitrate to the target bitrate to the ratio of the current value of each parameter to the target value of the corresponding parameter.

The mapping relationship can be such that the ratio of the current value of each parameter to the target value of the corresponding parameter is equal to the ratio of the current bitrate to the target bitrate, that is:

C_{A}/T_{A}=R/R′, where C_{A} represents the current value of a parameter A. T_{A} represents the target value of the parameter A, R represents the current bitrate, and R′ represents the target bitrate.

For example, if the bitrate is adjusted from 3 mbps to 1.5 mbps, then T_{A}=½C_{A}.

The mapping relationship can alternatively be such that the ratio of the current value of each parameter to the target value of the corresponding parameter is equal to the ratio of the current bitrate to the target bitrate, multiplied with a weight coefficient of the corresponding parameter, that is:

C_{A}/T_{A}=α_{A}R/R′, where α_{A} represents the weight coefficient of a parameter A, which ranges from 0 to 1, where if there is a large influence of the parameter A upon the bitrate, then the weight coefficient α_{A} will be larger.

The second sub-operation S1042 is to calculate the target value of each parameter according to the ratio of the current value of the corresponding parameter to the target value of the corresponding parameter, and the current value of the corresponding parameter.

The operation S105 is to modify the value of each parameter to the target value corresponding thereto to thereby adjust the bitrate in real time.

The operation S106 is to perform subsequent encoding to synchronization of the frames using the value of each parameter modified after the bitrate is adjusted in real time.

Since the target value is a predicated value as a function of previous encoding at the target bitrate, the bitrate will converge rapidly to the target bitrate while subsequent encoding to synchronization of the frames is being performed using the value of each parameter modified, for the purpose of transitioning smoothly while the bitrate is being adjusted during encoding.

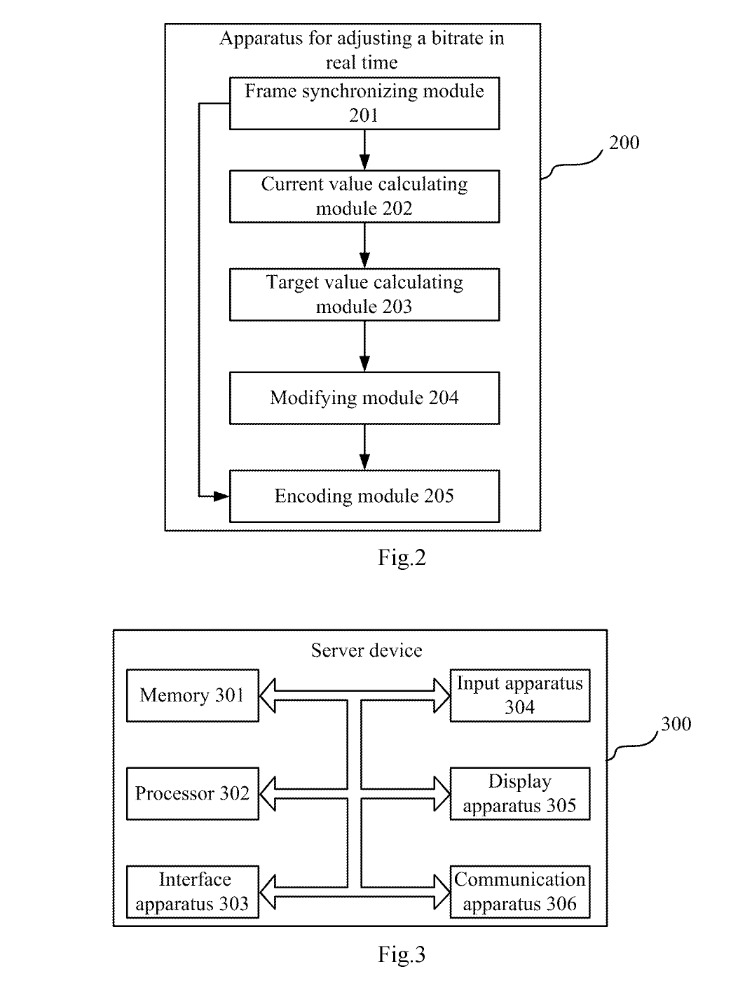

An embodiment of the disclosure further provides an apparatus for adjusting a bitrate in real time, and FIG. 2 illustrates a principle structural block diagram of an implementation of the apparatus.

As illustrated in FIG. 2, the apparatus 200 for adjusting a bitrate in real time includes a frame synchronizing module 201, a current value calculating module 202, a target value calculating module 203, a modifying module 204, and an encoding module 205, where:

The frame synchronizing module 201 is configured to synchronize frames across multiple threads in response to a bitrate adjusting instruction;

The current value calculating module 202 is configured to obtain parameters in a bitrate control logic to determine the bitrate, after the frames are synchronized, and to calculate the value of each parameter at the current bitrate as a current value;

The target value calculating module 203 is configured to calculate a target value of each parameter at a target bitrate according to a proportional relationship between the current bitrate and the target bitrate corresponding to the bitrate adjusting instruction, and the current value of the corresponding parameter;

The modifying module 204 is configured to modify the value of each parameter to the target value corresponding thereto; and

The encoding module 205 is configured to perform subsequent encoding to synchronization of the frames, using the value of each parameter modified.

The target value calculating module 203 can be configured to determine that the ratio of the current value of each parameter to the target value of the corresponding parameter is equal to the ratio of the current bitrate to the target bitrate.

The frame synchronizing module 201 can be configured to control each thread to finish current logic operations in the current frames for processing.

The current value calculating module 202 can be configured to obtain at least two parameters including the average of complexities of contents in a period of time of interest, and the number of bits processed in the period of time of interest. Furthermore the bitrate control logic corresponding to the current value calculating module 202 can particularly be a H.264 based bitrate control logic.

An embodiment of the disclosure further provides a server device which includes in an aspect includes the apparatus 200 above for adjusting a bitrate in real time.

FIG. 3 illustrates a principle structural block diagram of an implementation of the server device according to the embodiment of the disclosure in another aspect.

As illustrated in FIG. 3, the server device 300 includes a memory 301 and a processor 302, where the memory 301 is configured to store instructions for controlling the processor 302 to operate to perform the method above for adjusting a bitrate in real time.

Additionally as illustrated in FIG. 3, the server device can further include interface apparatus 303, input apparatus 304, display apparatus 305, communication apparatus 306, etc. Although there are a number of apparatus illustrated in FIG. 3, the embodiment of the disclosure may involve only a part of the apparatus, e.g., the processor 301, the memory 302, etc.

For example, the communication apparatus 306 can communicate in a wired or wireless manner.

For example, the interface apparatus 303 can include a USB interface, an RS232 interface, an RS485 interface, etc.

For example, the input means 304 can include a touch screen, a button, etc.

For example, the display means 305 can be a liquid crystal display screen, a touch display screen, etc.

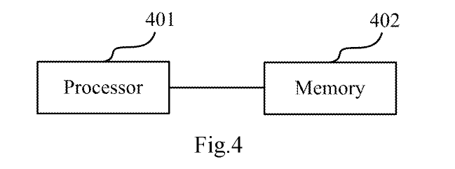

FIG. 4 illustrates a schematic structural diagram of apparatus for adjusting a bitrate in real time in accordance with some embodiments, wherein the apparatus includes:
at least one processor 401; and
a memory 402 communicably connected with the at least one processor for storing instructions executable by the at least one processor, wherein execution of the instructions by the at least one processor causes the at least one processor to:
synchronize frames across multiple threads in response to a bitrate adjusting instruction;
obtain parameters in a bitrate control logic to determine the bitrate after the frames are synchronized, and calculate the value of each parameter at the current bitrate as a current value;
calculate a target value of each parameter at a target bitrate according to a proportional relationship between the current bitrate and the target bitrate corresponding to the bitrate adjusting instruction and the current value of the corresponding parameter;
modify the value of each parameter to the target value corresponding thereto; and
perform subsequent encoding to synchronization of the frames, using the value of each parameter modified.

In some embodiments, execution of the instructions by the at least one processor further causes the at least one processor to:
determine that the ratio of the current value of each parameter to the target value of the corresponding parameter is equal to the ratio of the current bitrate to the target bitrate.

In some embodiments, execution of the instructions by the at least one processor further causes the at least one processor to: control each thread to finish current logic operations in the current frames for processing.

An embodiment of the disclosure provides a non-transitory computer-readable storage medium storing executable instructions that, when executed by an electronic device with a touch-sensitive display, cause the electronic device to:
synchronize frames across multiple threads in response to a bitrate adjusting instruction;
obtain parameters in a bitrate control logic to determine the bitrate after the frames are synchronized, and calculate the value of each parameter at the current bitrate as a current value;
calculate a target value of each parameter at a target bitrate according to a proportional relationship between the current bitrate and the target bitrate corresponding to the bitrate adjusting instruction and the current value of the corresponding parameter;
modify the value of each parameter to the target value corresponding thereto; and
perform subsequent encoding to synchronization of the frames, using the value of each parameter modified.

In some embodiments, the non-transitory computer-readable storage medium further cause the apparatus to:
determine that the ratio of the current value of each parameter to the target value of the corresponding parameter is equal to the ratio of the current bitrate to the target bitrate.

In some embodiments, the non-transitory computer-readable storage medium further cause the apparatus to:
control each thread to finish current logic operations in the current frames for processing.

The respective embodiments above have been described by focusing on their differences from the other embodiments, but those skilled in the art shall appreciate that the respective embodiments above can be applied separately or in combination as needed.

The respective embodiments in the specification have been described progressively, each of the embodiments has been described by focusing on its differences from the other embodiments, and the description of their commonalities can be applied to each other. However those skilled in the art shall appreciate that the respective embodiments can be applied separately or in combination as needed. Moreover the embodiments of the apparatus correspond to the embodiments of the method, so the embodiments of the apparatus have been described in brevity, and reference can be made to the description of the corresponding components in the embodiments of the method for details of those components in the embodiments of the apparatus. The embodiments of the apparatus have been described above merely by way of an example, and the modules described as separate components may or may not be physically separate.

The disclosure can be embodied as an apparatus, a method, and/or a computer program product. The computer program product can include a computer readable storage medium on which computer readable program instructions for causing a processor to implement the respective aspects of the disclosure are carried.

The computer readable storage medium can be a tangible device which can hold and store instructions for use by an instruction executing device. The computer readable storage medium can be, for example, but will not be limited to an electronic storage device, a magnetic storage device, an optical storage device, an electromagnetic storage device, a semiconductor storage device, or any appropriate combination thereof. More particular examples (a non-exhaust listing) of the computer readable storage medium include a portable computer disk, a hard disc, an Random Access Memory (RAM), a Read Only Memory (ROM), an Erasable Programmable Read Only Memory (EPROM) or a flash memory, a Static Random Access Memory (SRAM), a Compact Disk-Read Only Memory (CD-ROM), a Digital Versatile Disc (DVD), a memory stick, a floppy disk, a mechanically encoded device, e.g., a punched card, or a protrusion structure in a concave groove, on which instructions are stored, and any appropriate combination thereof. The computer readable storage medium as referred here to shall not be construed as an instantaneous signal per se, e.g., a radio wave, or another electromagnetic wave propagating freely, an electromagnetic wave propagating through a waveguide or another transmission medium (e.g., a light pulse propagating through an optic fiber cable), or an electronic signal transmitted over a wire.

The computer readable program instructions as referred here to can be downloaded from the computer readable storage medium to respective computing/processing devices or to external computers or external storage devices over a network, e.g., the Internet, a local area network, a wide area network and/or a wireless network. The network can include a copper transmission cable, optic fiber transmission, radio transmission, a router, a firewall, a switch, a gateway computer, and/or an edge server. A network adaptation card or a network interface in each computing/processing device receives the computer readable program instructions from the network, and forwards the computer readable program instructions for storage in the computer readable storage mediums in the respective computing/processing devices.

The computer readable program instructions for performing the operations of the disclosure can be source codes or object codes written in assembling instructions, Instruction Set Architecture (ISA) instructions, machine instructions, machine related instructions, micro codes, firmware instructions, state setting data, or any combination of one or more programming languages including an object oriented programming language, such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, an electronic circuit can be customized individually using state information of the computer readable program instructions, e.g., a programmable logic circuit, a Field programmable Gate Array (FPGA), or a Programmable Logic Array (PLA), where the electronic circuit can execute the computer readable program instructions to thereby implement the respective aspects of the disclosure.

Aspects of the present disclosure have been described here with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational operations to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which includes one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions. As well known to those skilled in the art, an implementation in hardware, an implementation in software, and an implementation in both hardware and software may be equivalent to each other.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. The scope of the disclosure shall be as defined in the appended claims.

1-10. (canceled)

11. A method for adjusting a bitrate in real time, the method comprising:
synchronizing frames across multiple threads in response to a bitrate adjusting instruction;
obtaining parameters in a bitrate control logic to determine the bitrate, after the frames are synchronized;
calculating the value of each parameter at the current bitrate as a current value;
calculating a target value of each parameter at a target bitrate, according to a proportional relationship between the current bitrate and the target bitrate corresponding to the bitrate adjusting instruction and the current value of the corresponding parameter;
modifying the value of each parameter to the target value corresponding thereto; and
performing subsequent encoding to synchronization of the frames, using the value of each parameter modified.

12. The method according to claim 11, wherein calculating the target value of each parameter at the target bitrate according to the proportional relationship between the current bitrate and the target bitrate corresponding to the bitrate adjusting instruction, and the current value of the corresponding parameter comprises:
determining that the ratio of the current value of each parameter to the target value of the corresponding parameter is equal to the ratio of the current bitrate to the target bitrate.

13. The method according to claim 11, wherein the parameters comprise the average of complexities of contents in a period of time of interest, and the number of bits processed in the period of time of interest.

14. The method according to claim 13, wherein the bitrate control logic is an H264 based bitrate control logic.

15. The method according to claim 11, wherein synchronizing the frames across the multiple threads comprises:
controlling each thread to finish current logic operations in the current frames for processing.

16. The method according to claim 12, wherein synchronizing the frames across the multiple threads comprises:
controlling each thread to finish current logic operations in the current frames for processing.

17. The method according to claim 13, wherein synchronizing the frames across the multiple threads comprises:
controlling each thread to finish current logic operations in the current frames for processing.

18. The method according to claim 13, wherein synchronizing the frames across the multiple threads comprises:
controlling each thread to finish current logic operations in the current frames for processing.

19. An apparatus for adjusting a bitrate in real time, the apparatus comprising:
at least one processor; and
a memory communicably connected with the at least one processor for storing instructions executable by the at least one processor, wherein execution of the instructions by the at least one processor causes the at least one processor to:
synchronize frames across multiple threads in response to a bitrate adjusting instruction;
obtain parameters in a bitrate control logic to determine the bitrate after the frames are synchronized, and calculate the value of each parameter at the current bitrate as a current value;
calculate a target value of each parameter at a target bitrate according to a proportional relationship between the current bitrate and the target bitrate corresponding to the bitrate adjusting instruction and the current value of the corresponding parameter;
modify the value of each parameter to the target value corresponding thereto; and
perform subsequent encoding to synchronization of the frames, using the value of each parameter modified.

20. The apparatus according to claim 19, wherein execution of the instructions by the at least one processor further causes the at least one processor to:
determine that the ratio of the current value of each parameter to the target value of the corresponding parameter is equal to the ratio of the current bitrate to the target bitrate.

21. The apparatus according to claim 19, wherein execution of the instructions by the at least one processor further causes the at least one processor to: control each thread to finish current logic operations in the current frames for processing.

22. The apparatus according to claim 20, wherein execution of the instructions by the at least one processor further causes the at least one processor to: control each thread to finish current logic operations in the current frames for processing.

23. A non-transitory computer-readable storage medium storing executable instructions that, when executed by an apparatus for adjusting a bitrate in real time, cause the apparatus to:
synchronize frames across multiple threads in response to a bitrate adjusting instruction;
obtain parameters in a bitrate control logic to determine the bitrate after the frames are synchronized, and calculate the value of each parameter at the current bitrate as a current value;
calculate a target value of each parameter at a target bitrate according to a proportional relationship between the current bitrate and the target bitrate corresponding to the bitrate adjusting instruction and the current value of the corresponding parameter;
modify the value of each parameter to the target value corresponding thereto; and
perform subsequent encoding to synchronization of the frames, using the value of each parameter modified.

24. The non-transitory computer-readable storage medium according to claim 23, further cause the apparatus to:
determine that the ratio of the current value of each parameter to the target value of the corresponding parameter is equal to the ratio of the current bitrate to the target bitrate.

25. The non-transitory computer-readable storage medium according to claim 23, further cause the apparatus to:
control each thread to finish current logic operations in the current frames for processing.

26. The non-transitory computer-readable storage medium according to claim 24, further cause the apparatus to:
control each thread to finish current logic operations in the current frames for processing.
